(19) United States
(12) Patent Application Publication
(10) Pub. No.: US 2010/0025876 A1
(43) Pub. Date: Feb. 4, 2010

(54) BINDER REMOVAL FROM PARTICULATE BODIES

(76) Inventors: Martin Biler, Novy Jicin (CZ); Ivana Zednickova, Lanskroun (CZ); Tomas Karnik, Lanskroun (CZ); Zdenek Sita, Lanskroun (CZ)

Correspondence Address: DORITY & MANNING, P.A., POST OFFICE BOX 1449, GREENVILLE, SC, 29602-1449, US

(21) Appl. No.: 12/298,303

(22) PCT Filed: Jun. 29, 2007
(86) PCT No.: PCT/GB07/02440

§ 371 Date: Apr. 7, 2009

(30) Foreign Application Priority Data
Jul. 6, 2006 (GB) 0613491.0

(51) Int. Cl. C08J 9/26; H01B 1/00; H01B 1/02

(52) U.S. Cl. 264/49; 252/500; 252/512; 252/518.1

(57) ABSTRACT

The present invention relates to a method of manufacturing a porous article, in particular the anode of a valve action material based solid state capacitor, comprising the steps of combining a water soluble polymeric binder and particulate material before pressing the particulate material and the subsequent step of removing the binder form the pressed pellet. Thus, the present invention also relates to a method of removing a water soluble polymeric binder from pressed particulate material and to a composition comprising a water soluble polymeric binder for forming the anode of a valve action material based solid state capacitor.

The present invention relates to the field of forming articles by pressing particulate matter bound with a binder and the removal of the binder after pressing. In particular, the present invention concerns a method of manufacturing high purity sintered articles for use in solid state capacitors.

In the manufacture of valve action material based capacitors the anodes are typically formed by adding binder to a powdered form of the valve action material prior to pressing the powder into pellets. The binder improves the strength of the pellet and can contribute to more open porosity and higher capacitance. The binder also reduces the tendency of the powder to stick to the press die. In particular, the binder is used to make the valve action material more flowable to enable easier compacting and moulding. After compacting and moulding, the binder is removed from the pressed pellet typically by heating under vacuum so that the binder sublimes, distillates or decomposes. The anode is then sintered to fuse the powder into an integral article.

The choice of binder material in electrical or other high purity applications is limited by the requirement that minimal or no carbonaceous material is left in the pressed body after removal of the binder. The presence of carbon deposits is known to degrade the electrical quality of the anodic film electrochemically deposited on the surface of the sintered pellet. Flaws in the anodic film give rise to current leakage in the finished capacitor. Also, the choice of binder is limited since only those binders capable of being removed without oxygen being added to the anode during the removal process may be used. Binders currently used include camphor, certain waxes, certain polymers and high molecular weight carboxylic acids such as steric acid.

Recent advances in valve action metal technology mean that valve action metals may be manufactured as powders having relatively small average particle size. As a result, capacitors may be made with anodes having relatively small pellet porosity and large surface area following sintering. The advent of powdered valve action metal powder with relatively small diameter size particles and reduced pore size means that the binders currently used in the manufacture of a pressed pellet are not suitable since they may not be satisfactorily removed from the pressed pellet.

U.S. Pat. No. 5,470,525 discloses a method of removing binder from tantalum powder pellets by leaching in warm aqueous detergent solution followed by washing in clean water. Specifically, the binder is steric acid and the detergent is PEG. However, in the method disclosed in U.S. Pat. No. 5,470,525, the leaching process takes a considerable amount of time, typically many hours.

U.S. Pat. No. 6,375,710 discloses a method of removing water soluble binder from tantalum based pressed pellets by vacuum distillation or by water leaching. Specifically, the binder is dimethyl sulfone. However, dimethyl sufone is disadvantageous since it has a tendency to cause the powder to stick to a press die when pressed into pellets. Furthermore, dimethyl sulfone contains sulphur, which is hard to debind thermally.

WO 98/30348 discloses a method of removing binder from a tantalum based pressed pellet by contacting the pellet with an agent which is capable of reacting with the binder to produce a water-soluble derivative of the binder. The binder, typically, dissolves upon reaction with the agent and this may be removed from the pellet. Specifically, the binder is steric acid and the agent is an alkaline solution e.g. aqueous sodium hydroxide.

U.S. Pat. No. 6,075,083 discloses a composition comprising a metal or ceramic powder, a thermoplastic polymer and a cross-linking agent for cross-linking the thermoplastic polymer when heated. U.S. Pat. No. 6,075,083 also discloses a method of forming a sintered metal or ceramic object from the composition. The thermoplastic polymer is degraded by heating the composition to a sufficiently high temperature. The specific polymeric binders used are polyvinylacetate, polyvinylbutral or polyvinylformyl. PVA and PEOX are not disclosed.

WO 96/01163 discloses a method of removing a binder from pressed tantalum pellets by leaching the pellet in an aqueous detergent. The binder is selected from fatty acids such as stearic acid, ammonium bicarbonate and carbon wax. WO 96/01163, however, does not disclose the use of PVA or PEOX as binders or their removal from sintered bodies.

EP 1,029,895 discloses a binder system for use in powder injection molding. The binder system is described as comprising polymers and the specific example given is a binder system comprising soluble polyethylene glycol (PEG) and PVB. EP 1,029,895 discloses that the PEG can be removed from the pressed pellet by a solvent which is essentially water, although EP 1,029,895 is silent as to how the PVB is removed. In any event, EP 1,029,895 does not disclose a PVA or PEOX as a binder.

GB 2,368,850 discloses the pressing of metal powders in to compacts using a DMSO binder. DMSO may be completely removed from compacts pressed from the tantalum by vacuum distillation of by water leaching. GB 2,368,850 does not disclose the use of water soluble polymeric binders in general nor PVA or PEOX.

EP 0,509,625 discloses a method of injection molding of zirconia ceramic material powder to form sintered products using an organic binder. The organic binders are selected from PEG, glycol or glycerol fatty acid ester, polyvinylbutral, polyvinylmethylether, polyvinylethylether and priopionic acid vinyl. The methods require the step of removing the binder by contacting the molding with alcohol. EP 0,509,625 does not disclose PVA or PEOX as polymeric binders.

JP 5-331502 discloses a method of removing a binder from various powdered metals or ceramics by coating the powder grains with a first insoluble binder, such as PMMA, followed by mixing the powder and binder with a soluble second resin having a higher softening temperature than that of the first resin. The soluble second resin is then leached by mixing with water and the first resin remains bound to the particles. JP 5-331502 does not disclose the use of PVA or PEOX as a binder.

It is an object of the present invention to provide an alternative binder to those used in the prior art which is capable of being used in the manufacture of a sintered anode from modern valve action materials, but which is easily removed from the pressed pellet to leave minimal contamination in the final sintered anode.

In a first aspect, the present invention provides a method of manufacturing a porous article comprising
(a) combining a binder and particulate material;
(b) pressing said binder and particulate material to form a pressed pellet;
(c) removing said binder;
wherein said binder is a water soluble polymeric binder.

In a second aspect, the present invention provides a method of removing a binder from an article formed from a pressed particulate material comprising contacting the article with an aqueous solution capable of leaching said binder from said article or subjecting said porous article comprising said binder to vacuum distillation wherein said binder is a water soluble polymeric binder.

In a third aspect, the present invention provides a composition for forming anodes for valve action material based solid state capacitors, said composition comprising a valve action material and a water soluble polymeric binder.

The present inventors have discovered that water soluble polymeric binders are effective for making pressed pellets from valve action material powder. The present inventors have also found that valve action material powder may be manipulated more easily when being pressed to form a pellet by inclusion of a water soluble polymeric binder in the valve action material powder. Further, and of particular advantage, it has been found that a water soluble polymeric binders may be easily removed from the pressed pellet by washing or vacuum distillation by virtue of their solubility in water, to leave virtually no carbon contaminants remaining in the pressed pellet.

The water soluble polymeric binder may be combined with the particulate material in any suitable manner. A powder form of the water soluble polymeric binder may be dry blended with the particulate material powder by mixing before pressing. Alternatively, the water soluble polymeric binder may be wet blended by first dissolving the binder in a suitable solvent, such as water, then adding the solution of binder to the particulate material.

Once the pellet is pressed, the solvent may be removed from the pellet by evaporation.

The particulate material is preferably a valve action material. The valve action material may be any suitable metal that is used to manufacture anodes of solid state, capacitors. Preferably, the valve action material is powdered niobium or tantalum metal or a powdered form of their conductive oxides. More preferably, the valve action material is provided as a metal oxide powder such as NbO.

The a water soluble polymeric binder is mixed with said particulate material from 0.5 wt % to 8 wt %, more preferably 0.5 wt % to 2 wt %, based upon the weight of the valve action material powder.

After pressing the valve action material powder and the water soluble polymeric binder to form a pellet, the binder is removed from the pellet by a suitable method such as vacuum distillation or by leaching (i.e. washing the compact with water or other aqueous solution). By virtue of their solubility, the water soluble polymeric binder may be completely removed from the pellet by either method, to leave the pellet uncontaminated with carbon.

For leaching, the pressed pellet may be contacted with water by immersion of the pellet in water. In this way, water enters the pressed pellet through pores present therein to contact with the water soluble polymeric binder. The water may be heated to facilitate the removal of the binder from the article. Preferably leaching is performed at a water temperature of from 50° C. to 95° C., more preferably from 60° C. to 80° C.

The water may be stirred or otherwise agitated during the removal process. Alternatively, the pellet itself may be agitated while immersed thereby enhancing the penetration of water into the article. Suitable agitation apparatus will be known to the person skilled in the art.

The leaching process may be repeated several times to ensure as much binder as possible is removed from the pellet. After a round of leaching, any water soluble polymeric binder remaining in the pellet may be removed by washing the pellet in clean water.

Vacuum distillation may be used to remove the water soluble polymeric binder from the pellet. Vacuum distillation comprises heating the pellet under a vacuum. Preferably the pellet is heated to at least 500° C. for a time sufficient to remove the water soluble polymeric binder. Preferably the pellet is heated to 400° C.

After washing the article may be dried and then sintered to form a consolidated product.

The present invention has particular application in the production of valve action material based capacitors whereby the anode is manufactured by sintering a pressed pellet of valve action material, and then incorporated into a capacitor. However, the present invention may also find utility in other applications requiring pressed particulate bodies which will be known to the skilled person.

Preferably, for all aspects of the present invention, the water soluble polymeric binder is polyvinyl alcohol (PVA) or poly (2-ethyloxazoline) (PEOX). Advantageously, PVA and PEOX have very low toxicity (LDA for rat is more than 20,000 mg/kg) and therefore is safer to use than some of the binders known in the art.

Following is a description by way of example only, of methods of putting the present invention into effect, in which Table 1 shows the carbon content of a NbO pellet formed by pressing NbO powder and PVA or PEOX binder following subsequent removal of the binder by leaching or vacuum distillation.

In order to illustrate the low level of residual carbon contamination remaining in a pressed pellet when PVA or PEOX is used as a binder the following procedure was performed. The carbon content was measured on a Leco carbon analyser HF 300. An alumina crucible was pre-heated at 1000° C. for 6 hrs to burn the impurities. The crucible was then cooled and stored in an exicator. Approximately 1 g of valve metal material was dosed to the crucible in presence of a copper granulate accelerator. The crucible was then heated to 1000° C. for 20 seconds. The carbon content was automatically detected by a built-in carbon detector.

The results in Table 1 show that PVA and PEOX may be removed from pellets either by vacuum distillation or leaching in water to a level comparable to the control PEG sample. In fact, the results show that vacuum distillation is able to completely remove all traces of PVA (at concentrations of at less than 2 wt %) and PEOX from a pellet. Thus, PVA and PEOX may be used as a binder in the formation of a pressed pellet of valve action material powder and may subsequently be satisfactorily removed to leave minimal or no carbon contaminants in the pressed pellet.

### Results

TABLE 1

| Amount of Binder | Carbon (ppm)* | Carbon (ppm)** |
|---|---|---|
| 1.0% PEG | 50 | 0 |
| 0.5% PVA | 330 | 0 |
| 1.0% PVA | 380 | 0 |
| 2.0% PVA | 400 | 930 |
| 0.5% PEOX | 80 | 0 |
| 1.0% PEOX | 30 | 0 |
| 2.0% PEOX | 60 | 0 |

*NbO anodes immersed in static deionised water at 85° C. for 2 × 40 min and at 70° C. for 150 min.
**NbO anodes treated by vacuum distillation at 500° C.
PEG as control

1. A method of manufacturing a porous article comprising
(a) combining a binder and particulate material;
(b) pressing said binder and particulate material to form a pressed pellet;
(c) removing said binder;
wherein said binder is a water soluble polymeric binder.

2. A method of claim 1 further comprising the step of sintering said pressed pellet after said binder is removed.

3. A method of claim 1 wherein said binder and particulate material are provided as a premixed composition.

4. A method of claim 1 wherein said binder is dry blended with said particulate material by mixing.

5. A method of claim 1 wherein said binder is wet blended with said particulate material.

6. A method of claim 1 wherein said particulate material is powdered niobium or tantalum or conductive oxides thereof.

7. A method of claim 1 wherein said particulate material is powdered niobium or powdered conductive oxide thereof.

8. A method of removing a binder from an article formed from a pressed particulate material comprising contacting the article with an aqueous solution capable of leaching said binder from said article or subjecting said article comprising said binder to vacuum distillation wherein said binder is a water soluble polymeric binder.

9. A method of claim 8 wherein said leaching is performed by contacting said article with water at a temperature of from 50° C. to 95° C.

10. A method of claim 8 wherein said vacuum distillation is performed by heating said pressed pellet under a vacuum at a temperature of at least 400° C.

11. A composition for forming anodes for valve action material based solid state capacitors, said composition comprising a valve action material and a water soluble polymeric binder.

12-16. (canceled)

17. A method of claim 1, wherein said water soluble polymeric binder is polyvinyl alcohol (PVA) or poly (2-ethyloxazoline) (PEOX).

18. A method of claim 1, wherein said particulate material is a valve action material.

19. A method of claim 18, wherein said valve action material is powdered niobium or tantalum or conductive oxides thereof.

20. A method of claim 18, wherein said valve action material is powdered niobium or conductive oxide thereof.

21. A method of claim 1, wherein said binder is provided in an amount of from about 0.5 wt % to 8 wt % based up on the weight of the particulate material.

22. A composition of claim 11, wherein said water soluble polymeric binder is polyvinyl alcohol (PVA) or poly (2-ethyloxazoline) (PEOX).

23. A composition of claim 11, wherein said particulate material is a valve action material.

24. A composition of claim 23, wherein said valve action material is powdered niobium or tantalum or conductive oxides thereof.

25. A composition of claim 23, wherein said valve action material is powdered niobium or conductive oxide thereof.

26. A composition of claim 11, wherein said binder is provided in an amount of from about 0.5 wt % to 8 wt % based up on the weight of the particulate material.
